(19) United States
(12) Patent Application Publication
(10) Pub. No.: US 2018/0068178 A1
(43) Pub. Date: Mar. 8, 2018

(54) Real-time Expression Transfer for Facial Reenactment

(71) Applicants: MAX-PLANCK-GESELLSCHAFT ZUR FÖRDERUNG D. WISSENSCHAFTEN E.V., Munchen (DE); THE BOARD OF TRUSTEES OF THE LELAND STANFORD JUNIOR UNIVERSITY, PALO ALTO, CA (US); FRIEDRICH-ALEXANDER-UNIVERSITÄT ERLANGEN-NÜRNBERG, Erlangen (DE)

(72) Inventors: Christian THEOBALT, Saarbrucken (DE); Michael ZOLLHOEFER, Saarbrucken (DE); Marc STAMMINGER, Erlangen (DE); Justus THIES, Buchen (DE); Matthias NIESSNER, Palo Alto, CA (US)

(21) Appl. No.: 15/256,710

(22) Filed: Sep. 5, 2016

(51) Int. Cl. G06K 9/00; G06K 9/32; G06T 7/00; G06T 13/80; G06T 11/60; G06T 11/40; G06T 11/00

(52) U.S. Cl. CPC G06K 9/00315; G06K 9/3241; G06K 9/00221; G06K 9/00362; G06T 7/004; G06T 13/80; G06K 2209/21; G06T 11/40; G06T 11/001; G06T 7/0051; G06T 2207/10016; G06T 2207/10024; G06T 2207/30201; G06T 11/60

(57) ABSTRACT

A computer-implemented method for tracking a human face in a target video includes obtaining target video data of a human face; and estimating parameters of a target human face model, based on the target video data. A first subset of the parameters represents a geometric shape and a second subset of the parameters represents an expression of the human face. At least one of the estimated parameters is modified in order to obtain new parameters of the target human face model, and output video data are generated based on the new parameters of the target human face model and the target video data.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### INTRODUCTION

In recent years, several approaches have been proposed for facial expression re-targeting, aimed at transferring facial expressions captured from a real subject to a virtual CG avatar. Facial reenactment goes one step further by transferring the captured source expressions to a different, real actor, such that the new video shows the target actor reenacting the source expressions photo-realistically. Reenactment is a far more challenging task than expression re-targeting as even the slightest errors in transferred expressions and appearance and a human user will notice slight inconsistencies with the surrounding video. Most methods for facial reenactment proposed so far work offline and only few of those produce results that are close to photo-realistic [DALE, K., SUNKAVALLI, K., JOHNSON, M. K., VLASIC, D., MATUSIK, W., AND PFISTER, H. 2011. Video face replacement. ACM TOG 30, 6, 130; GARRIDO, P., VALGAERTS, L., REHMSEN, O., THORMAEHLEN, T., PEREZ, P., AND THEOBALT, C. 2014. Automatic face reenactment. In Proc. CVPR].

However, new applications require, e.g. a multilingual video-conferencing setup in which the video of one participant may be altered in real time to photo-realistically reenact the facial expression and mouth motion of a real-time translator. Application scenarios reach even further as photo-realistic reenactment enables the real-time manipulation of facial expression and motion in videos while making it challenging to detect that the video input is spoofed.

### BRIEF SUMMARY OF THE INVENTION

These objects are achieved by a method and a device according to the independent claims. Advantageous embodiments are defined in the dependent claims.

By providing a separate representation of an identity/geometric shape and an expression of a human face, the invention allows re-enacting a facial expression without changing the identity.

### BRIEF DESCRIPTION OF THE FIGURES

The patent or application file contains at least one drawing executed in color. Copies of this patent or patent application publication with color drawing(s) will be provided by the Office upon request and payment of the necessary fee.

These and other aspects of the invention will be more readily understood when considering the following description of detailed embodiments of the invention, in connection with the drawing, in which

FIG. 1 is an illustration of a live facial reenactment technique by tracking the expression of a source actor and transferring it to a target actor at real-time rates according to a first embodiment of the invention

FIG. 2 is a schematic illustration of a facial reenactment pipeline according to the first embodiment of the invention.

FIG. 3 shows a schematic overview of a real-time fitting pipeline according to the first embodiment of the invention.

FIG. 4: shows a non-zero structure of JT for 20 k visible pixels.

FIG. 5: illustrates a convergence of a Gauss-Newton solver according to the first embodiment of the invention for different facial performances. The horizontal axis breaks up convergence for each captured frame (at 30 fps); the vertical axis shows the fitting error. Even for expressive motion, it converges well within a single frame.

FIG. 6: illustrates wrinkle-level detail transfer according to the first embodiment of the invention. From left to right: (a) the input source frame, (b) the rendered target geometry using only the target albedo map, (c) the transfer result, (d) a re-texturing result.

FIG. 7: illustrates final compositing according to the first embodiment of the invention: the modified target geometry is rendered with the target albedo under target lighting and transfer skin detail. After rendering a person-specific teeth proxy and warping a static mouth cavity image, all three layers are overlaid on top of the original target frame and blended using a frequency based strategy.

FIG. 8: illustrates re-texturing and re-lighting of a facial performance according to the first embodiment of the invention.

FIG. 9: illustrates a tracking accuracy of a method according to the first embodiment of the invention. Left: the input RGB frame, the tracked model overlay, the composite and the textured model overlay. Right: the reconstructed mesh of [Valgaerts et al. 2012], the shape reconstructed according to the invention, and the color coded distance between both reconstructions.

FIG. 10: illustrates stability under lighting changes.

FIG. 11: illustrates stability under head motion. From top to bottom: (a) 2D features, (b) 3D landmark vertices according to the first embodiment of the invention, (c) overlaid face model, (d) textured and overlaid face model. The inventive method recovers the head motion, even when the 2D tracker fails.

FIG. 12: illustrates an importance of the different data terms in an objective function according to the first embodiment of the invention: tracking accuracy is evaluated in terms of geometric (middle) and photometric error (bottom). The final reconstructed pose is shown as an overlay on top of the input images (top). Mean and standard deviations of geometric and photometric error are 6.48 mm/40.00 mm and 0.73 px/0.23 px for Feature, 3.26 mm/1.16 mm and 0.12 px/0.03 px for Features+Color, 2.08 mm/0.16 mm and 0.33 px/0.19 px for Feature+Depth, 2.26 mm/0.27 mm and 0.13 px/0.03 px for Feature+Color+Depth.

FIG. 13: illustrates re-texturing and re-lighting a facial performance according to the first embodiment.

FIG. 14: shows a schematic overview of a method according to a second embodiment of the invention.

FIG. 15: illustrates mouth retrieval according to the second embodiment: an appearance graph is used to retrieve new mouth frames. In order to select a frame, similarity to the previously-retrieved frame is enforced while minimizing the distance to the target expression.

FIG. 16: shows a comparison of the RGB reenactment according to the second embodiment to the RGB-D reenactment of the first embodiment.

FIG. 17: shows results of the reenactment system according to the second embodiment. Corresponding run times are listed in Table 1. The length of the source and resulting output sequences is 965, 1436, and 1791 frames, respectively; the length of the input target sequences is 431, 286, and 392 frames, respectively.

### DETAILED EMBODIMENTS

To synthesize and render new human facial imagery according to a first embodiment of the invention, a parametric 3D face model is used as an intermediary representation of facial identity, expression, and reflectance. This model also acts as a prior for facial performance capture, rendering it more robust with respect to noisy and incomplete data. In addition, the environment lighting is modeled to estimate the illumination conditions in the video. Both of these models together allow for a photo-realistic re-rendering of a person's face with different expressions under general unknown illumination.

As a face prior, a linear parametric face model M_{geo}(α,δ) is used which embeds the vertices vᵢε [symbol] ³, iε{1, . . . , n} of a generic face template mesh in a lower-dimensional subspace. The template is a manifold mesh defined by the set of vertex positions V=[vᵢ] and corresponding vertex normals N=[nᵢ], with |V|=|N|=n. The M_{geo}(α,δ) parameterizes the face geometry by means of a set of dimensions encoding the identity with weights α and a set of dimensions encoding the facial expression with weights δ. In addition to the geometric prior, also a prior is used for the skin albedo M_{alb}(β), which reduces the set of vertex albedos of the template mesh C=[cᵢ], with cᵢε [symbol] ³ and |C|=n, to a linear subspace with weights β. More specifically, the parametric face model according to the first embodiment is defined by the following linear combinations

M_{geo}(α,δ)=a_{id}+E_{id}α+Eₑₓₚδ, (1)

M_{alb}(β)=a_{alb}+E_{alb}β. (2)

Here M_{geo}ε [symbol] ³ⁿ and M_{alb}ε [symbol] ³ⁿ contain the n vertex positions and vertex albedos, respectively, while the columns of the matrices E_{id}, Eₑₓₚ, and E_{alb} contain the basis vectors of the linear subspaces. The vectors α, δ and β control the identity, the expression and the skin albedo of the resulting face, and a_{id} and a_{alb} represent the mean identity shape in rest and the mean skin albedo. While vᵢ and cᵢ are defined by a linear combination of basis vectors, the normals nᵢ can be derived as the cross product of the partial derivatives of the shape with respect to a (u; v)-parameterization.

The face model is built once in a pre-computation step. For the identity and albedo dimensions, one may use of the morphable model of BLANZ, V., AND VETTER, T. 1999. A morphable model for the synthesis of 3d faces. In Proc. SIGGRAPH, ACM Press/Addison-Wesley Publishing Co., 187-194. This model has been generated by non-rigidly deforming a face template to 200 high-quality scans of different subjects using optical flow and a cylindrical parameterization. It is assumed that the distribution of scanned faces is Gaussian, with a mean shape a_{id}, a mean albedo a_{alb}, and standard deviations σ_{oid} and σ_{alb}. The first 160 principal directions are used to span the space of plausible facial shapes with respect to the geometric embedding and skin reflectance. Facial expressions are added to the identity model by transferring the displacement fields of two existing blend shape rigs by means of deformation transfer [SUMNER, R. W., AND POPOVIĆ, J. 2004. Deformation transfer for triangle meshes. ACM TOG 23, 3, 399-405]. The used blend shapes have been created manually [ALEXANDER, O., ROGERS, M., LAMBETH, W., CHIANG, M., AND DEBEVEC, P. 2009. The Digital Emily Project: photoreal facial modeling and animation. In ACM SIGGRAPH Courses, ACM, 12:1-12:15] or by non-rigid registration to captured scans [CAO, C., WENG, Y., LIN, S., AND ZHOU, K. 2013. 3D shape regression for real-time facial animation. ACM TOG 32, 4, 41]. The space of plausible expressions is parameterized by 76 blendshapes, which turned out to be a good trade-off between computational complexity and expressibility. The identity is parameterized in PCA space with linearly independent components, while the expressions are represented by blend shapes that may be overcomplete.

To model the illumination, it is assumed that the lighting is distant and that the surfaces in the scene are predominantly Lambertian. This allows the use of a Spherical Harmonics (SH) basis [MUELLER, C. 1966. Spherical harmonics. Springer. PIGHIN, F., AND LEWIS, J. 2006. Performance-driven facial animation. In ACM SIGGRAPH Courses] for a low dimensional representation of the incident illumination.

Following RAMAMOORTHI, R., AND HANRAHAN, P. 2001. A signal-s processing framework for inverse rendering. In Proc. SIGGRAPH, ACM, 117-128, the irradiance in a vertex with normal n and scalar albedo c is represented using b=3 bands of SHs for the incident illumination:

$$L ( γ , n , c ) = c \cdot {\sum }_{k = 1}^{{b}^{2}} {γ}_{k} {Y}_{k} ( n ) , \qquad ( 3 )$$

with yₖ being the k-th SH basis function and γ=(γ1, . . . , γ_{b}_{²}) the SH coefficients. Since one only assumes distant light sources and ignores self-shadowing or indirect lighting, the irradiance is independent of the vertex position and only depends on the vertex normal and albedo. In the present embodiment, the three RGB channels are considered separately, thus irradiance and albedo are RGB triples. The above equation then gives rise to 27 SH coefficients (b²=9 basis functions per channel).

In order to represent the head pose and the camera projection onto the virtual image plane the origin and the axis of the world coordinate frame anchorcharted to the RGB-D sensor, while assuming that the camera to be calibrated. The model-to-world transformation for the face is then given by Φ(v)=Rv+t where R is a 3×3 rotation matrix and tε [symbol] ³ a translation vector. R is parameterized using Euler angles and, together with t, represents the 6-DOF rigid transformation that maps the vertices of the face between the local coordinates of the parametric model and the world coordinates. The known intrinsic camera parameters define a full perspective projection that transforms the world coordinates to image coordinates. With this, one may define an image formation model S(P), which allows to generate synthetic views of virtual faces, given the parameters P that govern the structure of the complete scene:

P=(α,β,δ,γ,R,t), (4)

with p=160+160+76+27+3+3=429 being the total amount of parameters. The image formation model enables the transfer of facial expressions between different persons, environments and viewpoints, but in order to manipulate a given video stream of a face, one first needs to determine the parameters P that faithfully reproduce the observed face in each RGB-D input frame.

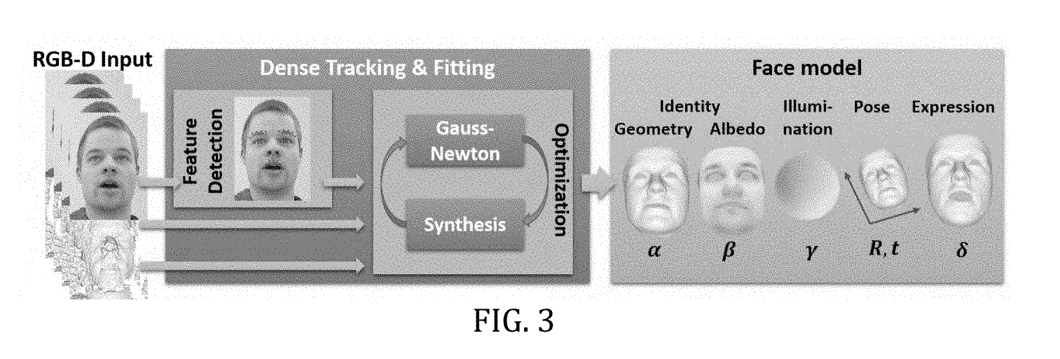

For the simultaneous estimation of the identity, facial expression, skin albedo, scene lighting, and head pose, the image formation model S(P) is fitted to the input of a commodity RGB-D camera recording an actor's performance. In order to obtain the best fitting parameters P that explain the input in real-time, an analysis-through-synthesis approach is used, where the image formation model is rendered for the old set of (potentially non-optimal) parameters and P further optimized by comparing the rendered image to the captured RGB-D input. An overview of the fitting pipeline is shown in FIG. 3.

The input for the facial performance capture system is provided by an RGB-D camera and consists of the measured input color sequence C_{I} and depth sequence X_{I}. It is assumed that the depth and color data are aligned in image space and can be indexed by the same pixel coordinates; i.e., the color and back-projected 3D position in an integer pixel location p=(i,j) is given by C_{I}(ρ)ε [symbol] ³ and X_{I}(ρ)ε [symbol] ³, respectively. The range sensor implicitly provides a normal field N_{I}, where N_{I}(ρ)ε [symbol] ³ is obtained as the cross product of the partial derivatives of X_{I} with respect to the continuous image coordinates.

The image formation model S(P), which generates a synthetic view of the virtual face, is implemented by means of the GPU rasterization pipeline. Apart from efficiency, this allows to formulate the problem in terms of 2D image arrays, which is the native data structure for GPU programs. The rasterizer generates a fragment per pixel p if a triangle is visible at its location and barycentrically interpolates the vertex attributes of the underlying triangle. The output of the rasterizer is the synthetic color C_{S}, the 3D position X_{S} and the normal N_{S} at each pixel p. Note that C_{S}(p), X_{S}(p), and N_{S}(p) are functions of the unknown parameters P. The rasterizer also writes out the barycentric coordinates of the pixel and the indices of the vertices in the covering triangle, which is required to compute the analytical partial derivatives with respect to P.

From now on, only pixels belonging to the set V of pixels for which both the input and the synthetic data is valid are considered.

The problem of finding the virtual scene that best explains the input RGB-D observations may be cast as an unconstrained energy minimization problem in the unknowns P. To this end, an energy may be formulated that can be robustly and efficiently minimized:

E(P)=E_{emb}(P)+w_{col}E_{col}(P)+ωₗₐₙEₗₐₙ(P)+ω_{reg}E_{reg}(P). (5)

The design of the objective takes the quality of the geometric embedding E_{emb}, the photo-consistency of the re-rendering E_{col}, the reproduction of a sparse set of facial feature points Eₗₐₙ, and the geometric faithfulness of the synthesized virtual head Ereg into account. The weights ω_{col}, ωₗₐₙ, and ω_{reg} compensate for different scaling of the objectives. They have been empirically determined and are fixed for all shown experiments.

The reconstructed geometry of the virtual face should match the observations captured by the input depth stream. To this end, one may define a measure that quantifies the discrepancy between the rendered synthetic depth map and the input depth stream:

E_{emb}(P)=ωₚₒᵢₙₜEₚₒᵢₙₜ(P)+ωₚₗₐₙₑEₚₗₐₙₑ(P). (6)

The first term minimizes the sum of the projective Euclidean point-to-point distances for all pixels in the visible set: V

$${E}_{point} ( P ) = {\sum }_{p ∈ V} {‖ {d}_{point} ( p ) ‖}_{2}^{2} , \qquad ( 7 )$$

with dₚₒᵢₙₜ(p)=X_{S}(p)−X_{I}(p) the difference between the measured 3D position and the 3D model point. To improve robustness and convergence, one may also use a first-order approximation of the surface-to-surface distance [CHEN, Y., AND MEDIONI, G. G. 1992. Object modelling by registration of multiple range images. Image and Vision Computing 10, 3, 145-155]. This is particularly relevant for purely translational motion where a point-to-point metric alone would fail. To this end, one measures the symmetric point-to-plane distance from model to input and input to model at every visible pixel:

$${E}_{plane} ( P ) = {\sum }_{p ∈ V} [ {d}_{plane}^{2} ( {N}_{S} ( ρ ) , ρ ) + {d}_{plane}^{2} ( {N}_{I} ( ρ ) , ρ ] , \qquad ( 8 )$$

with dₚₗₐₙₑ(n,ρ)=n^{T}dₚₒᵢₙₜ(ρ) the distance between the 3D point X_{S}(p) or X_{I}(p) and the plane defined by the normal n.

In addition to the face model being metrically faithful, one may require that the RGB images synthesized using the model are photo-consistent with the given input color images. Therefore, one minimizes the difference between the input RGB image and the rendered view for every pixel ρεV:

$${E}_{col} ( P ) = {\sum }_{ρ ∈ V} {‖ {C}_{S} ( ρ ) - {C}_{I} ( ρ ) ‖}_{2}^{2} , \qquad ( 9 )$$

where C_{S}(p) is the illuminated (i.e., shaded) color of the synthesized model. The color consistency objective introduces a coupling between the geometry of the template model, the per vertex skin reflectance map and the SH illumination coefficients. It is directly induced by the used illumination model L.

The face includes many characteristic features, which can be tracked more reliably than other points. In addition to the dense color consistency metric, one therefore tracks a set of sparse facial landmarks in the RGB stream using a state-of-the art facial feature tracker [SARAGIH, J. M., LUCEY, S., AND COHN, J. F. 2011. Deformable model fitting by regularized landmark mean-shift. IJCV 91, 2, 200-215]. Each detected feature fⱼ=(uⱼ; vⱼ) is a 2D location in the image domain that corresponds to a consistent 3D vertex vⱼ in the geometric face model. If F is the set of detected features in each RGB input frame, one may define a metric that enforces facial features in the synthesized views to be close to the detected features:

$${E}_{lan} ( P ) = {\sum }_{{f}_{j} ∈ F} {ω}_{conf , j} ‖ {f}_{j} - {Π ( Φ ( {v}_{j} ) ‖}_{2}^{2} . \qquad ( 10 )$$

The present embodiment uses 38 manually selected landmark locations concentrated in the mouth, eye, and nose regions of the face. Features are pruned based on their visibility in the last frame and a confidence ω_{conf} is assigned based on its trustworthiness. This allows to effectively prune wrongly classified features, which are common under large head rotations (>30°).

The final component of the objective function is a statistical regularization term that expresses the likelihood of observing the reconstructed face, and keeps the estimated parameters within a plausible range. Under the assumption of Gaussian distributed parameters, the interval [−3σ_{•,i,}+3σ_{•,i}] contains≈99% of the variation in human faces that can be reproduced by the model. To this end, constrain the model parameters α, β and δ are constrained to be statistically small compared to their standard deviation:

$${E}_{reg} ( P ) = {\sum }_{i = 1}^{160} [ {( \frac{{α}_{i}}{{σ}_{id , i}} )}^{2} + {( \frac{{β}_{i}}{{σ}_{alb , i}} )}^{2} ] + {\sum }_{i = 1}^{76} {( \frac{{δ}_{i}}{{σ}_{exp , i}} )}^{2} . \qquad ( 11 )$$

For the shape and reflectance parameters, σ_{id,i} and a_{alb,i} are computed from the 200 high-quality scans. For the blend shape parameters, σ_{exp,i} may be fixed to 1.

In order to minimize the proposed energy, one needs to compute the analytical derivatives of the synthetic images with respect to the parameters P. This is non-trivial, since a derivation of the complete transformation chain in the image formation model is required. To this end, one also emits the barycentric coordinates during rasterization at every pixel in addition to the indices of the vertices of the underlying triangle. Differentiation of S(P) starts with the evaluation of the face model M_{geo} and M_{alb}), the transformation to world space via Φ, the illumination of the model with the lighting model L, and finally the projection to image space via Π. The high number of involved rendering stages leads to many applications of the chain rule and results in high computational costs.

The proposed energy E(P): [symbol] ^{p}→ [symbol] Eq. (5) is non-linear in the parameters P, and finding the best set of parameters P* amounts to solving a non-linear least squares problem in the p unknowns:

$${P}^{*} = arg {min}_{P} E ( P ) . \qquad ( 12 )$$

Even at the moderate image resolutions used in this embodiment (640×480), the energy gives rise to a considerable amount of residuals: each visible pixel ρεV contributes with 8 residuals (3 from the point-to-point term of Eq. (6), 2 from the point-to-plane term of Eq. (8) and 3 from the color term of Eq. (9)), while the feature term of Eq. (10) contributes with 2·38 residuals and the regularizer of Eq. (11) with p−33 residuals. The total number of residuals is thus m=8|V|+76+ρ−33, which can equal up to 180 K equations for a close-up frame of the face. To minimize a non-linear objective with such a high number of residuals in real-time, a data parallel GPU-based Gauss-Newton solver is proposed that leverages the high computational throughput of modern graphic cards and exploits smart caching to minimize the number of global memory accesses.

The non-linear least-squares energy E(P) is minimized in a Gauss-Newton framework by reformulating it in terms of its residual r: [symbol] ^{ρ}→ [symbol] ^{m}, with r(P)=(r₁(P), . . . , rₘ(P))^{T}. If it is assumed that one already has an approximate solution Pₖ, one seeks for a parameter increment ΔP that minimizes the first-order Taylor expansion of r(P) around P^{k}. So one may approximate

E(P^{k}+ΔP)≈∥r(P^{k})+J(P^{k})ΔP∥₂², (13)

for the update ΔP, with J(P^{k}) the m×p Jacobian of r(P^{k}) in the current solution. The corresponding normal equations are

J^{T}(P^{k})J(P^{k})ΔP=−J^{T}(P^{k})r(Pₖ), (14)

and the parameters are updated as P^{k+1}=P^{k}+ΔP. The normal equations are solved iteratively using a preconditioned conjugate gradient (PCG) method, thus allowing for efficient parallelization on the GPU (in contrast to a direct solve). Moreover, the normal equations need not to be solved until convergence since the PCG step only appears as the inner loop (analysis) of a Gauss-Newton iteration. In the outer loop (synthesis), the face is re-rendered and the Jacobian is recomputed using the updated barycentric coordinates. Jacobi preconditioning is used, where the inverse of the diagonal elements of J^{T} J are computed in the initialization stage of the PCG.

Convergence may be accelerated by embedding the energy minimization in a multi-resolution coarse-to-fine framework. To this end, one successively blurs and resamples the input RGB-D sequence using a Gaussian pyramid with 3 levels and applies the image formation model on the same reduced resolutions. After finding the optimal set of parameters on the current resolution level, a prolongation step transfers the solution to the next finer level to be used as an initialization there.

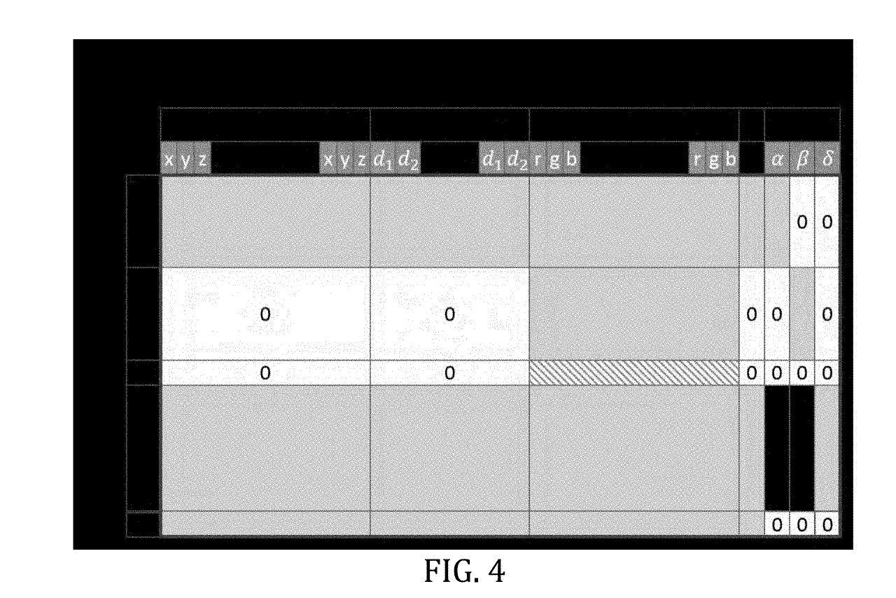

The normal equations (14) are solved using a novel data-parallel PCG solver that exploits smart caching to speed up the computation. The most expensive task in each PCG step is the multiplication of the system matrix J^{T} J with the previous descent direction. Precomputing J^{T} J would take O(n³) time in the number of Jacobian entries and would be too costly for real-time performance, so instead one applies J and J^{T} in succession. For the present problem J is block-dense because all parameters, except for β and γ, influence each residual (see FIG. 4). In addition, one optimizes for all unknowns simultaneously and the energy has a larger number of residuals. Hence, repeatedly recomputing the Jacobian would require significant read access from global memory, thus significantly affecting run time performance.

The key idea to adapting the parallel PCG solver to deal with a dense Jacobian is to write the derivatives of each residual in global memory, while pre-computing the right-hand side of the system. Since all derivatives have to be evaluated at least once in this step, this incurs no computational overhead. J, as well as J^{T}, are written to global memory to allow for coalesced memory access later on when multiplying the Jacobian and its transpose in succession. This strategy allows to better leverage texture caches and burst load of data on modern GPUs. Once the derivatives have been stored in global memory, the cached data can be reused in each PCG iteration by a single read operation.

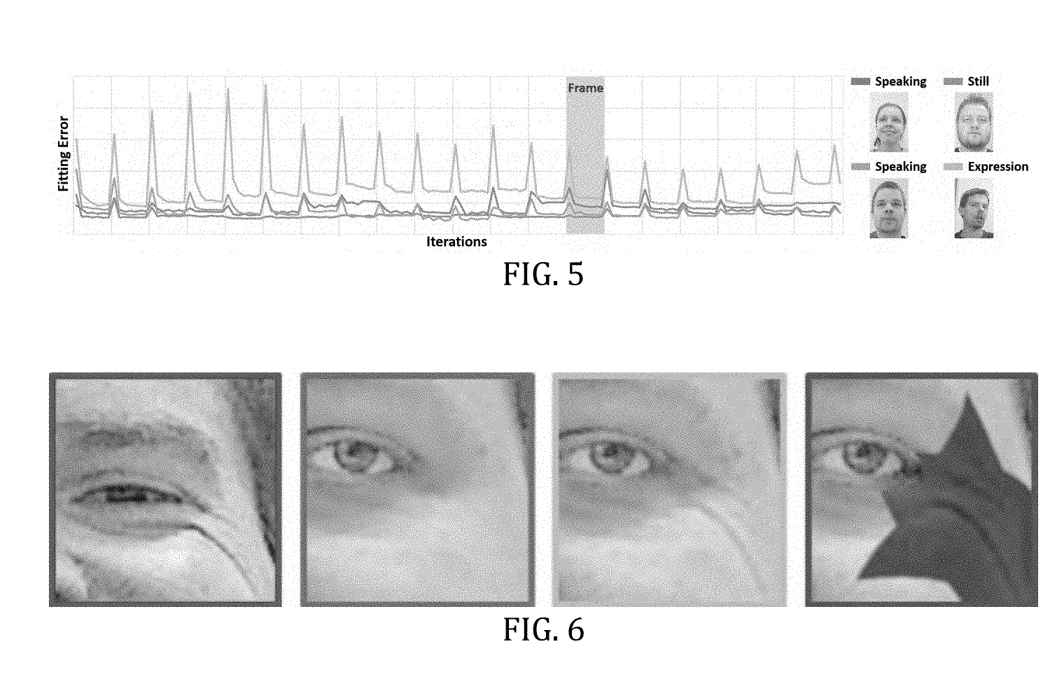

The convergence rate of this data-parallel Gauss-Newton solver for different types of facial performances is visualized in FIG. 5. These timings are obtained for an input frame rate of 30 fps with 7 Gauss-Newton outer iterations and 4 PCG inner iterations. Even for expressive motion, the solution converges well within a single time step.

As it is assumed that facial identity and reflectance for an individual remain constant during facial performance capture, one does not optimize for the corresponding parameters on-the-fly. Both are estimated in an initialization step by running the optimizer on a short control sequence of the actor turning his head under constant illumination.

In this step, all parameters are optimized and the estimated identity and reflectance are fixed for subsequent capture. The face does not need to be in rest for the initialization phase and convergence is usually achieved between 5 and 10 frames.

For the fixed reflectance, one does not use the values given by the linear face model, but may compute a more accurate skin albedo by building a skin texture for the face and dividing it by the estimated lighting to correct for the shading effects. The resolution of this texture is much higher than the vertex density for improved detail (2048×2048 in the experiments) and is generated by combining three camera views (front, 20° left and 20° right) using pyramid blending [ADELSON, E. H., ANDERSON, C. H., BERGEN, J. R., BURT, P. J., AND OGDEN, J. M. 1984. Pyramid methods in image processing. RCA engineer 29, 6, 33-41]. The final high-resolution albedo map is used for rendering.

The real-time capture of identity, reflectance, facial expression, and scene lighting, opens the door for a variety of new applications. In particular, it enables on-the-fly control of an actor in a target video by transferring the facial expressions from a source actor, while preserving the target identity, head pose, and scene lighting. Such face reenactment, for instance, can be used for video-conferencing, where the facial expression and mouth motion of a participant are altered photo-realistically and instantly by a real-time translator or puppeteer behind the scenes.

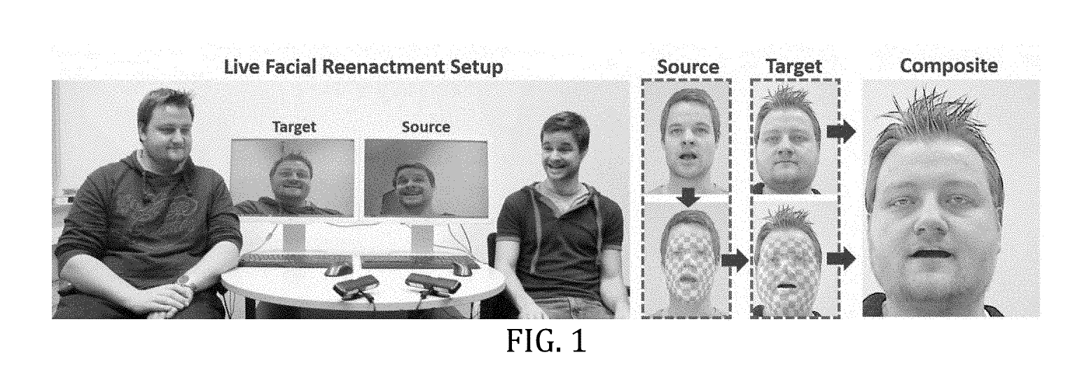

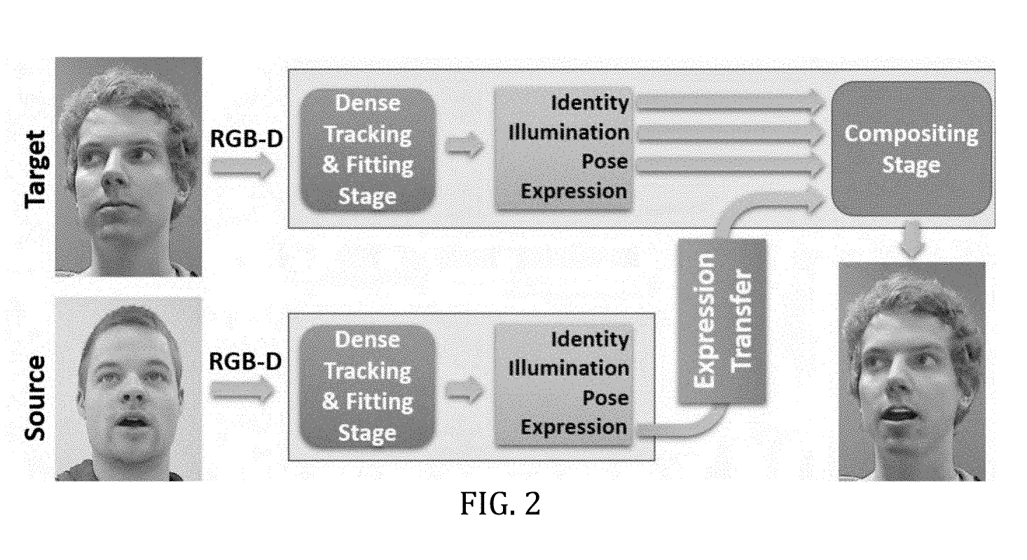

To perform live face reenactment, a setup is built consisting of two RGB-D cameras, each connected to a computer with a modern graphics card (see FIG. 1). After estimating the identity, reflectance, and lighting in a calibration step, the facial performance of the source and target actor are captured on separate machines. During tracking, one obtains the rigid motion parameters and the corresponding non-rigid blend shape coefficients for both actors. The blend shape parameters are transferred from the source to the target machine over an Ethernet network and applied to the target face model, while preserving the target head pose and lighting. The modified face is then rendered and blended into the original target sequence, and displayed in real-time on the target machine.

A new performance for the target actor is synthesized by applying the 76 captured blend shape parameters of the source actor to the personalized target model for each frame of target video. Since the source and target actor are tracked using the same parametric face model, the new target shapes can be easily expressed as

M_{geo}(αₜ,δₛ)=a_{id}+E_{id}αₜ+Eₑₓₚδₛ, (15)

where αₜ are the target identity parameters and δₛ the source expressions. This transfer does not influence the target identity, nor the rigid head motion and scene lighting, which are preserved. Since identity and expression are optimized separately for each actor, the blend shape activation might be different across individuals. In order to account for person-specific offsets, the blendshape response is subtracted for the neutral expression prior to transfer.

After transferring the blend shape parameters, the synthetic target geometry is rendered back into the original sequence using the target albedo and estimated target lighting as explained above.

Fine-scale transient skin detail, such as wrinkles and folds that appear and disappear with changing expression, are not part of the face model, but are important for a realistic re-rendering of the synthesized face. To include dynamic skin detail in the reenactment pipeline, wrinkles are modeled in the image domain and transferred from the source to the target actor. The wrinkle pattern of the source actor is extracted by building a Laplacian pyramid of the input source frame. Since the Laplacian pyramid acts as a band-pass filter on the image, the finest pyramid level will contain most of the high-frequency skin detail. The same decomposition is performed for the rendered target image and the source detail level is copied to the target pyramid using the texture parameterization of the model. In a final step, the rendered target image is recomposed using the transferred source detail.

FIG. 6 illustrates in detail the transfer strategy, with the source input frame shown on the left. The second image shows the rendered target face without detail transfer, while the third image shows the result obtained using the inventive pyramid scheme. The last image shows a re-texturing result with transferred detail obtained by editing the albedo map.

The face model only represents the skin surface and does not include the eyes, teeth, and mouth cavity. While the eye motion of the underlying video is preserved, the teeth and inner mouth region are re-generated photo-realistically to match the new target expressions.

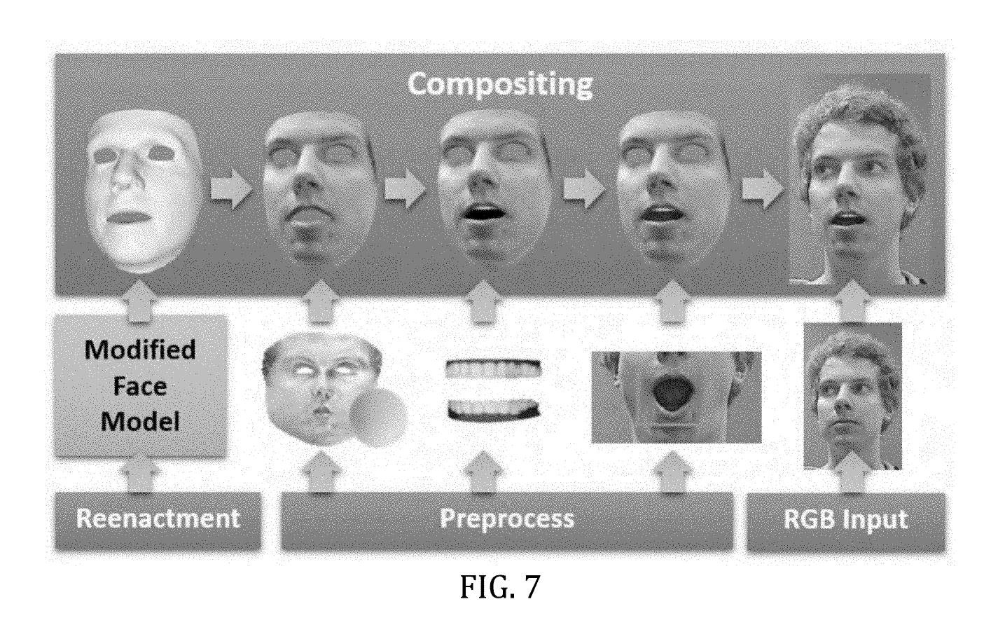

This is done in a compositing step, where the rendered face is combined with a teeth and inner mouth layer before blending the results in the final reenactment video (see FIG. 7).

To render the teeth, two textured 3D proxies (billboards) are used for the upper and lower teeth that are rigged relative to the blend shapes of the face model and move in accordance with the blend shape parameters. Their shape is adapted automatically to the identity by means of anisotropic scaling with respect to a small, fixed number of vertices. The texture is obtained from a static image of an open mouth with visible teeth and is kept constant for all actors.

A realistic inner mouth is created by warping a static frame of an open mouth in image space. The static frame is recorded in the calibration step and is illustrated in FIG. 7. Warping is based on tracked 2D landmarks around the mouth and implemented using generalized barycentric coordinates [MEYER, M., BARR, A., LEE, H., AND DESBRUN, M. 2002. Generalized barycentric coordinates on irregular polygons. Journal of Graphics Tools 7, 1, 13-22]. The brightness of the rendered teeth and warped mouth interior is adjusted to the degree of mouth opening for realistic shadowing effects.

The three image layers, produced by rendering the face and teeth and warping the inner mouth, need to be combined with the original background layer and blended into the target video. Compositing is done by building a Laplacian pyramid of all the image layers and performing blending on each frequency level separately. Computing and merging the Laplacian pyramid levels can be implemented efficiently using mipmaps on the graphics hardware. To specify the blending regions, binary masks are used that indicate where the face or teeth geometry is. These masks are smoothed on successive pyramid levels to avoid aliasing at layer boundaries, e.g., at the transition between the lips, teeth, and inner mouth.

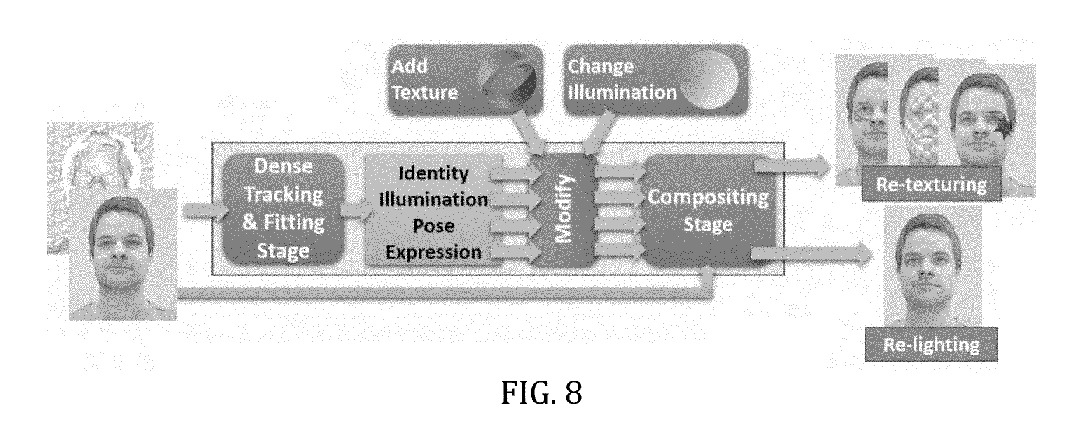

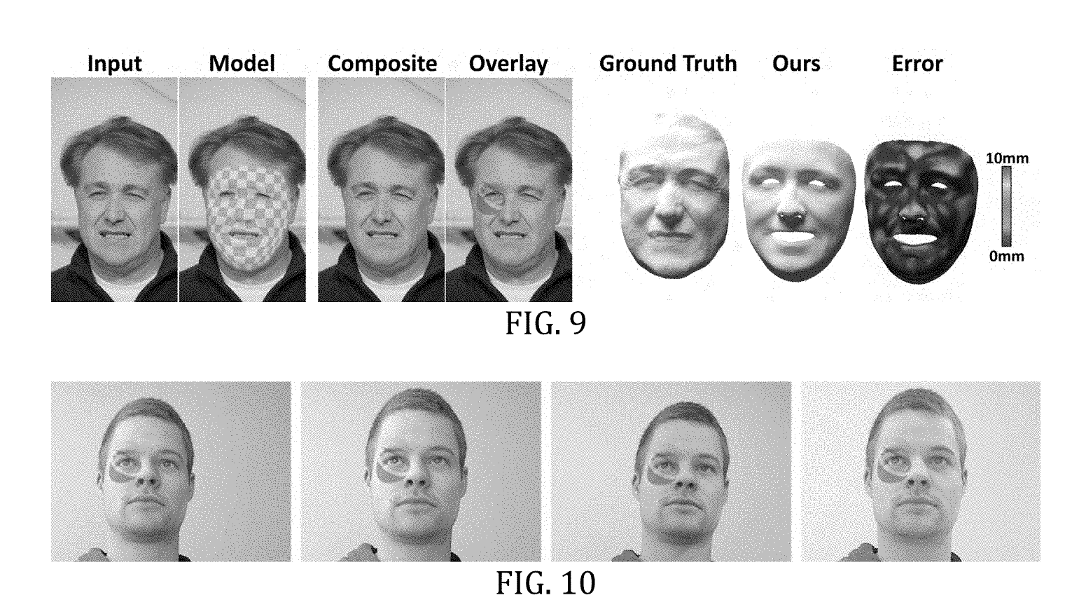

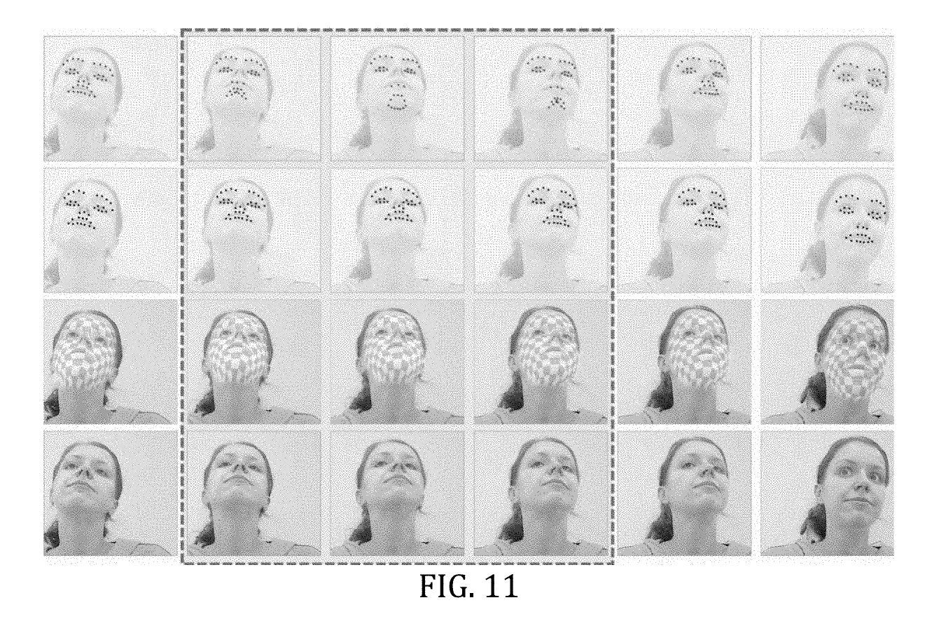

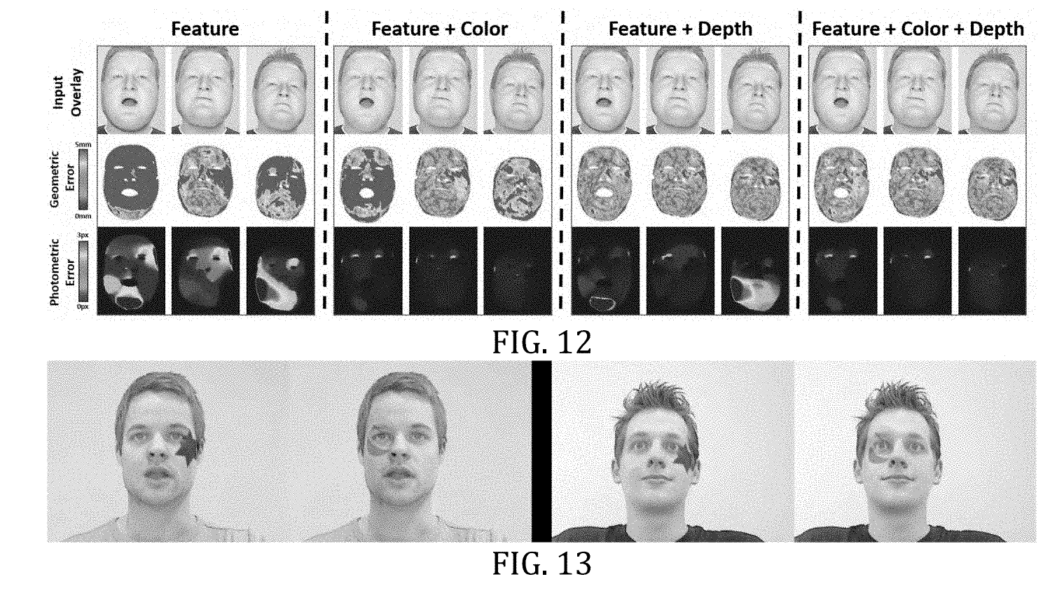

Face reenactment exploits the full potential of the inventive real-time system to instantly change model parameters and produce a realistic live rendering. The same algorithmic ingredients can also be applied in lighter variants of this scenario where one does not transfer model parameters between video streams, but modify the face and scene attributes for a single actor captured with a single camera. Examples of such an application are face re-texturing and re-lighting in a virtual mirror setting, where a user can apply virtual make-up or tattoos and readily find out how they look like under different lighting conditions. This requires to adapt the reflectance map and illumination parameters on the spot, which can be achieved with the rendering and compositing components described before. Since one only modifies the skin appearance, the virtual mirror does not require the synthesis of a new mouth cavity and teeth. An overview of this application is shown in FIG. 8.

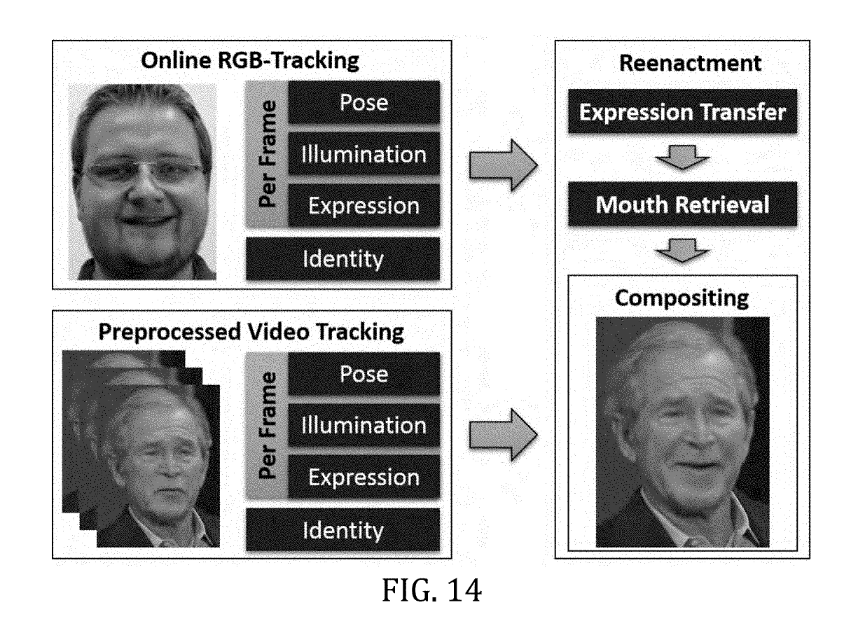

FIG. 14 shows an overview of a method according to a second embodiment of the invention. A new dense markerless facial performance capture method based on monocular RGB data is employed. The target sequence can be any monocular video; e.g., legacy video footage downloaded from YouTube with a facial performance. More particularly, one may first reconstruct the shape identity of the target actor using a global non-rigid model-based bundling approach based on a prerecorded training sequence. As this preprocess is performed globally on a set of training frames, one may resolve geometric ambiguities common to monocular reconstruction. At runtime, one tracks both the expressions of the source and target actor's video by a dense analysis-by-synthesis approach based on a statistical facial prior. In order to transfer expressions from the source to the target actor in real-time, transfer functions efficiently apply deformation transfer directly in the used low-dimensional expression space. For final image synthesis, the target's face is re-rendered with transferred expression coefficients and composited with the target video's background under consideration of the estimated environment lighting. Finally, an image-based mouth synthesis approach generates a realistic mouth interior by retrieving and warping best matching mouth shapes from the offline sample sequence. The appearance of the target mouth shapes is maintained.

A multi-linear PCA model based on [V. Blanz and T. Vetter. A morphable model for the synthesis of 3d faces. In Proc. SIGGRAPH, pages 187-194. ACM Press/Addison-Wesley Publishing Co., 1999; O. Alexander, M. Rogers, W. Lambeth, M. Chiang, and P. Debevec. The Digital Emily Project: photoreal facial modeling and animation. In ACM SIGGRAPH Courses, pages 12:1-12:15. ACM, 2009; C. Cao, Y. Weng, S. Zhou, Y. Tong, and K. Zhou. Facewarehouse: A 3D facial expression database for visual computing. IEEE TVCG, 20(3)413-425, 2014] is used. The first two dimensions represent facial identity—i.e., geometric shape and skin reflectance—and the third dimension controls the facial expression. Hence, a face is parameterized as:

M_{geo}(α,β)=a_{id}+E_{id}·α+Eₑₓₚ·δ, (16)

M_{alb}(β)=a_{alb}+E_{alb}·β. (17)

This prior assumes a multivariate normal probability distribution of shape and reflectance around the average shape a_{id}ε [symbol] ³ⁿ and reflectance a_{ialb}ε [symbol] ³ⁿ. The shape E_{id}ε [symbol] ^{3n×80}, reflectance E_{alb}ε [symbol] ^{3n×80}, and expression Eₑₓₚε [symbol] ^{3n×76} basis and the corresponding standard deviations σ_{id} ε [symbol] ⁸⁰, σ_{alb}ε [symbol] ⁸⁰, and σₑₓₚε [symbol] ⁷⁶ are given. The model has 53 K vertices and 106 K faces. A synthesized image C_{S} is generated through rasterization of the model under a rigid model transformation Φ(v) and the full perspective transformation Π(v). Illumination is approximated by the first three bands of Spherical Harmonics (SH) [23] basis functions, assuming Lambertian surfaces and smooth distant illumination, neglecting self-shadowing.

Synthesis is dependent on the face model parameters α, β, δ the illumination parameters γ, the rigid transformation R, t, and the camera parameters K defining Π. The vector of unknowns P is the union of these parameters.

Given a monocular input sequence, all unknown parameters P are reconstructed jointly with a robust variational optimization. The objective is highly non-linear in the unknowns and has the following components:

$$E ( P ) = \underbrace{{ω}_{col} {E}_{col} ( P ) + {ω}_{lan} {E}_{lan} ( P )}_{data} + \underbrace{{ω}_{reg} {E}_{reg} ( P )}_{prior} . \qquad ( 18 )$$

The data term measures the similarity between the synthesized imagery and the input data in terms of photoconsistency E_{col} and facial feature alignment Eₗₐₙ. The likelihood of a given parameter vector P is taken into account by the statistical regularizer E_{reg}. The weights w_{col}, wₗₐₙ, and w_{reg} balance the three different sub-objectives. In all of the experiments, w_{col}=1, wₗₐₙ=10, and w_{reg}=2.5·10⁻⁵.

In order to quantify how well the input data is explained by a synthesized image, the photo-metric alignment error may be measured on pixel level:

$${E}_{col} ( P ) = \frac{1}{\vert V \vert} {\sum }_{ρ ∈ V} {‖ {C}_{s} ( p ) - {C}_{I} ( p ) ‖}_{2} , \qquad ( 19 )$$

where C_{S} is the synthesized image, C_{I} is the input RGB image, and pεV denote all visible pixel positions in C_{S}. The l_{2,1}-norm [12] instead of a least-squares formulation is used to be robust against outliers. Distance in color space is based on l₂, while in the summation over all pixels an fi-norm is used to enforce sparsity.

In addition, feature similarity may be enforced between a set of salient facial feature point pairs detected in the RGB stream:

$${E}_{lan} ( P ) = \frac{1}{\vert F \vert} {\sum }_{{f}_{j} ∈ F} {ω}_{conf , j} ‖ {f}_{j} - {Π ( Φ ( {v}_{j} ) ‖}_{2}^{2} \qquad ( 20 )$$

To this end, a state-of-the-art facial landmark tracking algorithm by [J. M. Saragih, S. Lucey, and J. F. Cohn. Deformable model fitting by regularized landmark mean-shift. IJCV, 91 (2):200-215, 2011] may be employed. Each feature point fⱼεF⊂ [symbol] ² comes with a detection confidence ω_{conf,j} and corresponds to a unique vertex vⱼ=M_{geo}(α,δ)ε [symbol] ³ of the face prior. This helps avoiding local minima in the highly-complex energy landscape of E_{col}(P).

Plausibility of the synthesized faces may be enforced based on the assumption of a normal distributed population. To this end, the parameters are enforced to stay statistically close to the mean:

$${E}_{reg} ( P ) = {\sum }_{i = 1}^{80} [ {( \frac{{α}_{i}}{{σ}_{id , i}} )}^{2} + {( \frac{{β}_{i}}{{σ}_{alb , i}} )}^{2} ] + {\sum }_{i = 1}^{76} {( \frac{{δ}_{i}}{{σ}_{exp , i}} )}^{2} . \qquad ( 21 )$$

This commonly-used regularization strategy prevents degenerations of the facial geometry and reflectance, and guides the optimization strategy out of local minima.

The proposed robust tracking objective is a general unconstrained non-linear optimization problem. This objective is minimized in real-time using a data-parallel GPU based Iteratively Reweighted Least Squares (IRLS) solver. The key idea of IRLS is to transform the problem, in each iteration, to a non-linear least-squares problem by splitting the norm in two components:

$${‖ r ( P ) ‖}_{2} = \underbrace{{( {‖ r ( {P}_{old} ) ‖}_{2} )}^{- 1}}_{constant} \cdot {‖ r ( P ) ‖}_{2}^{2}$$

Here, r(•) is a general residual and P_{old} is the solution computed in the last iteration. Thus, the first part is kept constant during one iteration and updated afterwards. Each single iteration step is implemented using the Gauss-Newton approach. A single GN step is taken in every IRLS iteration and solve the corresponding system of normal equations J^{T}Jδ*=−J^{T} F based on PCG to obtain an optimal linear parameter update δ*. The Jacobian J and the systems' right hand side −J^{T}F are precomputed and stored in device memory for later processing. The multiplication of the old descent direction d with the system matrix J^{T}J in the PCG solver may be split up into two successive matrix-vector products.

In order to include every visible pixel ρεV in CS in the optimization process all visible pixels in the synthesized image are gathered using a parallel prefix scan. The computation of the Jacobian J of the residual vector F and the gradient JT F of the energy function are then parallelized across all GPU processors. This parallelization is feasible since all partial derivatives and gradient entries with respect to a variable can be computed independently. During evaluation of the gradient, all components of the Jacobian are computed and stored in global memory. In order to evaluate the gradient, a two-stage reduction is used to sum-up all local per pixel gradients. Finally, the regularizer and the sparse feature term are added to the Jacobian and the gradient.

Using the computed Jacobian J and the gradient J^{T} F, the corresponding normal equation J^{T}JΔx=−J^{T}F is solved for the parameter update Δx using a preconditioned conjugate gradient (PCG) method. A Jacobi preconditioner is applied that is precomputed during the evaluation of the gradient. To avoid the high computational cost of J^{T} J, the GPU-based PCG method splits up the computation of J^{T} Jₚ into two successive matrix-vector products.

In order to increase convergence speed and to avoid local minima, a coarse-to-fine hierarchical optimization strategy is used. During online tracking, only the second and third level are considered, where one and seven Gauss-Newton steps are run on the respective level. Within a Gauss-Newton step, always four PCG iterations are run.

The complete framework is implemented using DirectX for rendering and DirectCompute for optimization. The joint graphics and compute capability of DirectX11 enables the processing of rendered images by the graphics pipeline without resource mapping overhead. In the case of an analysis-by-synthesis approach, this is essential to runtime performance, since many rendering-to-compute switches are required.

For the present non-rigid model-based bundling problem, the non-zero structure of the corresponding Jacobian is block dense (cf. FIG. 4). In order to leverage the sparse structure of the Jacobian, the Gauss-Newton framework is used as follows: the computation of the gradient J^{T}(P)·F(P) and the matrix vector product J^{T}(P)·J(P)·x that is used in the PCG method are modified by defining a promoter function ψ: [symbol] ^{|P}^{_{global}}^{|+|P}^{_{local}}^{|}→ [symbol] ^{|P}^{_{global}}^{|+k·|P}^{_{local}}^{|} that lifts a per frame parameter vector to the parameter vector space of all frames (ψ_{f}⁻¹ is the inverse of this promoter function). P_{global} are the global parameters that are shared over all frames, such as the identity parameters of the face model and the camera parameters. P_{local} are the local parameters that are only valid for one specific frame (i.e., facial expression, rigid pose and illumination parameters). Using the promoter function ψ_{f} the gradient is given as

$${J}^{T} ( P ) \cdot F ( P ) = {\sum }_{f = 1}^{k} {ψ}_{f} ( {J}_{f}^{T} ( {ψ}_{f}^{- 1} ( P ) ) \cdot {F}_{f} ( {ψ}_{f}^{- 1} ( P ) ) ) ,$$

where J_{f} is the per-frame Jacobian matrix and F_{f} the corresponding residual vector.

As for the parameter space, another promoter function ψ_{f} is introduced, that lifts a local residual vector to the global residual vector. In contrast to the parameter promoter function, this function varies in every Gauss-Newton iteration since the number of residuals might change. The computation of J^{T} (P)·J(P)·x is split up into two successive matrix vector products, where the second multiplication is analogue to the computation of the gradient. The first multiplication is as follows:

$$J ( P ) \cdot x = {\sum }_{f = 1}^{k} {\hat{ψ}}_{f} ( {J}_{f} ( {ψ}_{f}^{- 1} ( P ) ) \cdot {ψ}_{f}^{- 1} ( x ) )$$

Using this scheme, the normal equations can be efficiently solved.

The Gauss-Newton framework is embedded in a hierarchical solution strategy. This hierarchy allows preventing convergence to local minima.

After optimization on a coarse level, the solution is propagated to the next finer level using the parametric face model. In experiments, the inventors used three levels with 25, 5, and 1 Gauss-Newton iterations for the coarsest, the medium and the finest level respectively, each with 4 PCG steps. The present implementation is not restricted to the number k of used key frames. The processing time is linear in the number of key frames. In the experiments, k=6 key frames were used to estimate the identity parameters resulting in a processing time of a few seconds (˜20 s).

To estimate the identity of the actors in the heavily under-constrained scenario of monocular reconstruction, a non-rigid model-based bundling approach is used. Based on the proposed objective, one jointly estimates all parameters over k key-frames of the input video sequence. The estimated unknowns are the global identity {α,β} and intrinsics K as well as the unknown per-frame pose {δ^{k}, R^{k}, t^{k}}ₖ and illumination parameters {γ^{k}}ₖ. A similar data-parallel optimization strategy as proposed for model-to-frame tracking is used, but the normal equations are jointly solved for the entire keyframe set. For the non-rigid model-based bundling problem, the non-zero structure of the corresponding Jacobian is block dense. The PCG solver exploits the non-zero structure for increased performance. Since all keyframes observe the same face identity under potentially varying illumination, expression, and viewing angle, one may robustly separate identity from all other problem dimensions. One may also solve for the intrinsic camera parameters of Π, thus being able to process uncalibrated video footage.

To transfer the expression changes from the source to the target actor while preserving person-specificness in each actor's expressions, a sub-space deformation transfer technique is used of operating directly in the space spanned by the expression blendshapes. This not only allows for the precomputation of the pseudo-inverse of the system matrix, but also drastically reduces the dimensionality of the optimization problem allowing for fast real-time transfer rates. Assuming source identity _S and target identity α^{T} fixed, transfer takes as input the neutral δ_{N}^{S}, deformed source δ^{S}, and the neutral target δ_{N}^{T} expression. Output is the transferred facial expression δ^{T} directly in the reduced sub-space of the parametric prior.

One first computes the source deformation gradients Aᵢε [symbol] ^{3×3} that transform the source triangles from neutral to deformed. The deformed target \hat{v}ᵢ=Mᵢ(α^{T},δ^{T}) is then found based on the un-deformed state vᵢ=Mᵢ(α^{T},δ_{N}^{T}) by solving a linear least-squares problem. Let (i₀, i₁, i₂) be the vertex indices of the i-th triangle, V=[vᵢ₁−vᵢ₀, vᵢ₂−vᵢ₀] and \hat{V}=[vᵢ₁−\hat{v}ᵢ₀,\hat{v}ᵢ₂−\hat{v}ᵢ₀], then the optimal unknown target deformation δ^{T} is the minimizer of:

$$E ( {δ}^{T} ) = {\sum }_{i = 1}^{\vert F \vert} {‖ {A}_{i} V - \hat{V} ‖}_{F}^{2} \qquad ( 22 )$$

This problem can be rewritten in the canonical least-squares form by substitution:

E(δ^{T})=∥Aδ^{T}−b∥₂². (23)

The matrix Aε [symbol] ^{6|F|×76} is constant and contains the edge information of the template mesh projected to the expression sub-space. Edge information of the target in neutral expression is included in the right-hand side bε [symbol] ^{6|F|}. b varies with δ^{S} and is computed on the GPU for each new input frame. The minimizer of the quadratic energy can be computed by solving the corresponding normal equations. Since the system matrix is constant, one may precompute its Pseudo Inverse using a Singular Value Decomposition (SVD). Later, the small 76×76 linear system is solved in real-time. No additional smoothness term is needed, since the blendshape model implicitly restricts the result to plausible shapes and guarantees smoothness.

In order to synthesize a realistic target mouth regions, one retrieves and warps the best matching mouth image from the target actor sequence. It is assumed that sufficient mouth variation is available in the target video. That the appearance of the target mouth is maintained. This leads to much more realistic results than either copying the source mouth region or using a generic 3D teeth proxy.

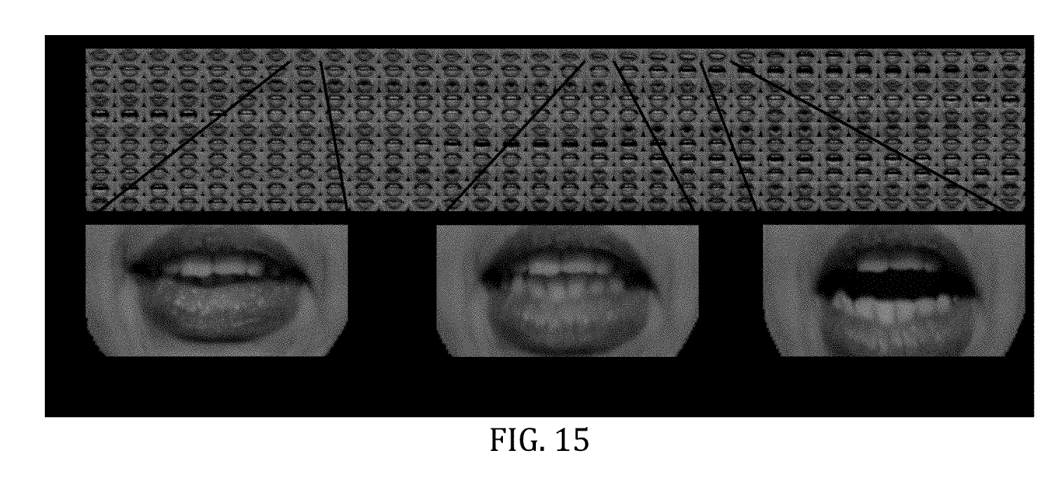

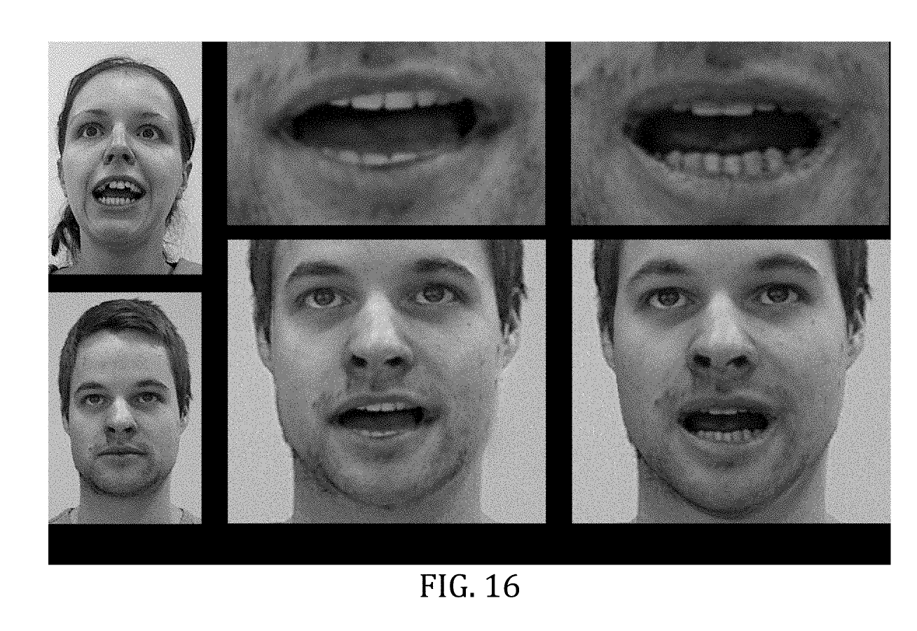

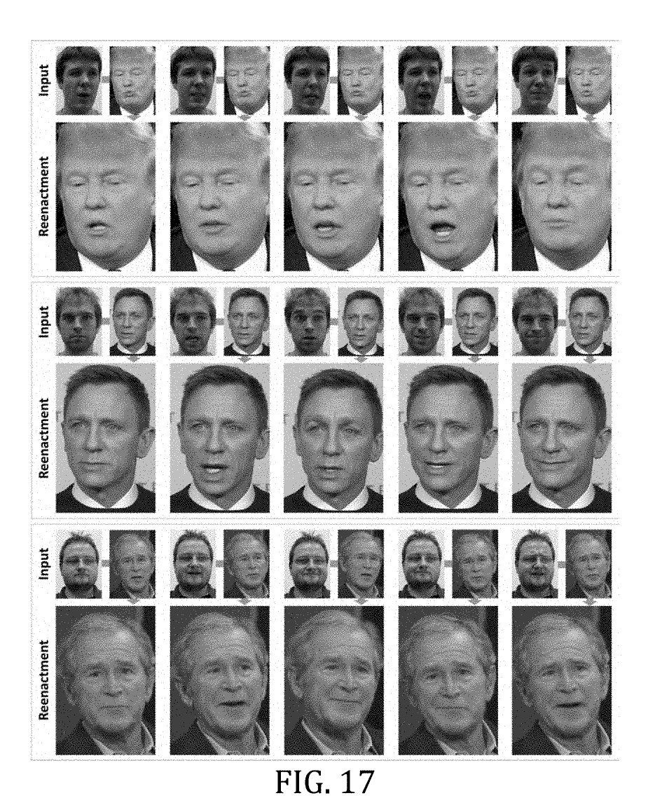

The inventive approach first finds the best fitting target mouth frame based on a frame-to-cluster matching strategy with a novel feature similarity metric. To enforce temporal coherence, a dense appearance graph is used to find a compromise between the last retrieved mouth frame and the target mouth frame (cf. FIG. 15).

The similarity metric according to the present embodiment is based on geometric and photometric features. The used descriptor K={R,δ,F,L} of a frame is composed of the rotation R, expression parameters δ, landmarks F, and a Local Binary Pattern (LBP) L. These descriptors K^{S} are computed for every frame in the training sequence. The target descriptor K^{T} consists of the result of the expression transfer and the LBP of the frame of the driving actor. The distance between a source and a target descriptor is measured as follows:

D(K^{T},Kₜ^{S},t)=Dₚ(K^{T},Kₜ^{S})+Dₘ(K^{T},Kₜ^{S})+Dₐ(K^{T},Kₜ^{S},t).

The first term Dₚ measures the distance in parameter space:

Dₚ(K^{T},Kₜ^{S})=∥δ^{T}−δₜ^{S}∥₂²+∥R^{T}−Rₜ^{S}∥_{F}².

The second term Dₘ measures the differential compatibility of the sparse facial landmarks:

$${D}_{m} ( {K}^{T} , {K}_{t}^{S} ) = {\sum }_{( i , j ) ∈ Ω} {( {‖ {F}_{i}^{T} - {F}_{j}^{T} ‖}_{2} - {‖ {F}_{t , i}^{S} - {F}_{t , j}^{S} ‖}_{s} )}^{2} .$$

Here Ω, is a set of predefined landmark pairs, defining distances such as between the upper and lower lip or between the left and right corner of the mouth. The last term Dₐ is an appearance measurement term composed of two parts:

Dₐ(K^{T},Kₜ^{S},t)=Dₗ(K^{T},Kₜ^{S})+ω_{c}(K^{T},Kₜ^{S})D_{c}(r,t).

τ is the last retrieved frame index used for the reenactment in the previous frame. Dₗ(K^{T}, Kₜ^{S}) measures the similarity based on LBPs that are compared via a Chi Squared Distance. D_{c}(τ,t) measures the similarity between the last retrieved frame τ and the video frame t based on RGB cross-correlation of the normalized mouth frames. The mouth frames are normalized based on the models texture parameterization (cf. FIG. 15). To facilitate fast frame jumps for expression changes, one may incorporate the weight ω_{c}(K^{T}, Kₜ^{S})=e^{-(D}^{ₘ}^{(K}^{^{T}}^{,K}^{ₜ}^{^{S}}⁾⁾^{²}. This frame-to-frame distance measure is applied in a frame-to-cluster matching strategy, which enables real-time rates and mitigates high-frequency jumps between mouth frames.

Utilizing the proposed similarity metric, one may cluster the target actor sequence into k=10 clusters using a modified k-means algorithm that is based on the pairwise distance function D. For every cluster, one selects the frame with the minimal distance to all other frames within that cluster as a representative. During runtime, one measures the distances between the target descriptor K^{T} and the descriptors of cluster representatives, and chooses the cluster whose representative frame has the minimal distance as the new target frame.

Temporal coherence may be improved by building a fully-connected appearance graph of all video frames. The edge weights are based on the RGB cross correlation between the normalized mouth frames, the distance in parameter space Dₚ, and the distance of the landmarks Dₘ. The graph enables to find an in-between frame that is both similar to the last retrieved frame and the retrieved target frame (see FIG. 15). This perfect match may be computed by finding the frame of the training sequence that minimizes the sum of the edge weights to the last retrieved and current target frame. One blends between the previously retrieved frame and the newly-retrieved frame in texture space on a pixel level after optic flow alignment. Before blending, one applies an illumination correction that considers the estimated Spherical Harmonic illumination parameters of the retrieved frames and the current video frame.

Finally, the new output frame is composed by alpha blending between the original video frame, the illumination-corrected, projected mouth frame, and the rendered face model.

We claim:

1. A computer-implemented method for tracking a human face in a target video, comprising the steps of:
obtaining target video data (RGB; RGB-D) of a human face;
estimating parameters (α, β, γ, δ) of a target human face model, based on the target video data;
characterized in that
a first subset of the parameters (α) represents a geometric shape and a second subset of the parameters (γ) represents an expression of the human face.

2. The method of claim 1, wherein a third subset of the parameters (β) represents a skin reflectance or albedo of the human face.

3. The method of claim 1, wherein the target human face model is linear in each subset of the parameters (α, β, γ, δ).

4. The method of claim 1, further comprising the step of estimating an environment lighting.

5. The method of claim 1, further comprising the step of estimating a head pose.

6. The method of claim 1, wherein the parameters (α, β, γ, δ) of the target human face model, are estimated based on the target video data (RGB; RGB-D), using an analysis-by-synthesis approach.

7. The method of claim 6, wherein the analysis-by-synthesis approach comprises a step of generating a synthetic view of a target human face and a step of fitting the synthetic view of the target human face to the target video data (RGB; RGB-D).

8. The method of claim 7, wherein the synthetic view is rendered photo-realistically.

9. The method of claim 7, wherein the step of fitting the synthetic view of the target human face to the target video data (RGB; RGB-D) comprises
decreasing a discrepancy between the synthetic view of the target human face and the target video data (RGB; RGB-D).

10. The method of claim 9, wherein the discrepancy is determined based on a photo-consistency metric.

11. The method of claim 10, wherein the photo-consistency metric quantifies a discrepancy between colors of the synthetic view and the target video data.

12. The method of claim 10, wherein the discrepancy is further determined based on a feature similarity metric.

13. The method of claim 12, wherein the feature similarity metric quantifies a discrepancy between facial features in the synthesized view and features detected in the target video data.

14. The method of claim 12, wherein the discrepancy is further determined based on a regularization constraint.

15. The method of claim 14, wherein the regularization constraint is based on a likelihood of observing the synthetic view in the target video data.

16. The method of claim 14, wherein the discrepancy is further determined based on a geometric consistency metric.

17. The method of claim 16, wherein the geometric consistency metric quantifies a discrepancy between a rendered synthetic depth map and an input depth stream.

18. The method of claim 9, wherein the step of decreasing is implemented using a data parallel Gauss-Newton solver.

19. The method of claim 18, wherein the data parallel Gauss-Newton solver is implemented on a GPU.

20. The method of claim 1, wherein the parameters (α) representing a geometric shape of the human face are estimated in an initialization step and kept fixed in the estimation of the remaining parameters.

21. A computer-implemented method for face re-enactment, comprising the steps of:
tracking a human face in a target video, using a method according to claim 1;
modifying at least one of the estimated parameters in order to obtain new parameters of the target human face model (α′, β′, γ′);
generating output video data (RGB), based on the new parameters (α′, β′, γ′) of the target human face model and the target video data; and
outputting the output video data.

22. The method of claim 21, wherein modifying at least one of the estimated parameters comprises re-lighting the human face, based on the acquired target video data and estimated lighting parameters.

23. The method of claim 21, wherein modifying at least one of the estimated parameters comprise augmenting the skin reflectance with virtual textures or make-up.

24. The method of claim 21, further comprising the steps of:
tracking a human face in a source video, using a method according to claim 1;
and wherein the second subset of the parameters (δₜ) representing an expression of the human face in the target video are modified, based on the second subset of the parameters (δₛ) representing an expression of the human face in the source video.

25. The method of claim 24, further comprising the step of transferring a wrinkle detail from the human face in the source video to the human face in the target video.

26. The method of claim 24, further comprising the step of:
re-generating a mouth and/or teeth region of the human face in the target video, based on the parameters estimated based on the source video.

27. The method of claim 26, wherein rendering the teeth uses one or two textured 3D proxies (billboards) that are rigged relative to the second subset of the parameters (γ) representing an expression of the human face in the source video.

28. The method of claim 26, wherein rendering the mouth region includes warping a static frame of an open mouth in image space.

29. The method of claim 24, wherein the second subset of the parameters (δₜ) representing an expression of the human face in the target video are modified by replacing them with the second subset of the parameters (δₛ) representing an expression of the human face in the source video.

30. The method of claim 24, wherein the second subset of the parameters (δₜ) representing an expression of the human face in the target video are modified further based on a subset of parameters (δ_{N}) representing a neutral expression of the human face in the source video.

31. The method of claim 1, wherein the parameter (α, β, γ, δ) of the target human face model are jointly estimated over a multitude (k) of keyframes of the target video.
